(19) United States
(12) Patent Application Publication
(10) Pub. No.: US 2016/0333032 A1
(43) Pub. Date: Nov. 17, 2016

(54) Complexing Agent and Preparation Method and Use Thereof

(71) Applicant: SONGHUA SUN, Quzhou City (CN)

(72) Inventors: SONGHUA SUN, Quzhou (CN); JING SUN, Quzhou (CN)

(21) Appl. No.: 15/111,291

(22) PCT Filed: Jan. 13, 2014
(86) PCT No.: PCT/CN2014/070526

§ 371 Date: Jul. 13, 2016

(51) Int. Cl. C07F 9/09; C25D 3/38; C25D 3/60; C25D 3/58; C25D 3/56; C08G 79/04; C25D 3/30

(52) U.S. Cl. CPC C07F 9/098; C08G 79/04; C25D 3/38; C25D 3/30; C25D 3/58; C25D 3/562; C25D 3/60

(57) ABSTRACT

The present invention relates to a complexing agent and preparation method and use thereof, the complexing agent has a general formula MₓH_{y}PₙO₃ₙ₊₁R_{z}, wherein M is any one or more of alkali metal ions and NH4+; R is acyl; x, n and z are positive integers, y is 0 or a positive integer and x+y+z=n+2. A preparing method of a complexing agent comprises: mixing alkali, carbonate or bicarbonate containing M, phosphoric acid and an acidic salt of monoprotic organic acids or polybasic organic acids containing an R group for reacting according to a molar ratio, then carrying one step polymerization on a reaction solution at 100-800° C. for 0.5-10h to obtain a finished product of the complexing agent; or drying the reaction solution firstly, and then polymerizing at 100-800° C. for 0.5-10h to obtain a finished product of the complexing agent. The complexing agent of the present invention is used for producing an electroplating solution and is convenient in machining, the prepared electroplating solution has high complexing capacity for metal, a complexing constant for copper ions is up to 10²⁶⁻²⁷ and far superior than that of the cyanide-free complexing agents in the prior art, and since the electroplating solution prepared from the complexing agent is good in quality and good in dispersity, a process current density range that can be adopted is wider and the electroplating solution has a wide application range.

### TECHNICAL FIELD

The present invention relates to a compound, and in particular, to a complexing agent and a preparing method and application thereof, belonging to the technical field of chemical engineering.

### BACKGROUND

A complexing agent is a compound that can form complexing ions with metal ions, except that the complexing agent is not or unnecessarily used in iron plating, nickel plating, chrome plating and copper plating in a few electroplating solutions, such as an acid solution, the complexing agent is required in silver plating, gold plating, copper plating, zinc plating, tin plating and copper tin alloy plating in most other electroplating solutions, such as an alkaline solution.

For a common complexing agent, such as cyanide, since cyanogens ions have excellent complexing capacity, cyaniding electroplating is the best electroplating manner and is widely used in the electroplating industry, but highly toxic compounds such as NaCN, KCN and CuCN are used in the cyaniding electroplating, its lethal amount for people is only 0.005 g, the cyanide harms the body health of an operator and pollutes the environment, in addition, sewage is hard to dispose, a sewage disposal cost is very high, therefore, in order to protect the environment and reduce public hazards, there is an urgent need to develop a complexing agent that replaces the cyanide for a cyanide-free electroplating process.

The current cyanide-free electroplating process mainly uses the following several cyanide-free complexing agents: 1. pyrophosphate copper plating: potassium pyrophosphate is taken as a complexing agent and has better complexing capacity, the stability constant of a complex formed by copper ions and pyrophosphate radicals is K₁=6.7, K₂=9.0, the electroplating solution taking the potassium pyrophosphate as the complexing agent is stable in quality, can adopt a wider process range, but has a defect that the electroplating cannot be performed on a steel substrate directly, otherwise replacement occurs on the substrate surface and causes a poor complexing capacity, therefore, the electroplating solution taking the potassium pyrophosphate as the complexing agent has a limited application range; 2. citrate copper plating: citric acid has higher complexing capacity and can generate a very stable substance together with the copper ions in the electroplating solution, the stability constant of a complex formed by the copper ions and the citrate radicals is K₂=19.30, no replacement phenomenon is generated on the surface of the steel substrate if such process is adopted to plate copper, but the process has the defect that the electroplating solution taking the citric acid as the complexing agent is not stable enough in quality, dispersity of the electroplating solution needs to be improved, and the electroplating solution is deteriorated at high temperature; 3. HEDP copper plating: HEDP is an organic phosphonate, has well complexing capacity, and can form relatively stable substances when reacting with many metals, the electroplating solution taking the HEDP as the complexing agent has stable quality and good dispersity, but the HEDP has the defect that it is found in actual production that the electroplating solution has a narrow process current density range, a plating easily generates copper powder, iron impurities in the electroplating solution reduce a deposition rate and result in a poor binding force between the plating and the substrate, therefore, the electroplating solution taking the HEDP as the complexing agent is not widely used.

### SUMMARY

An objective of the present invention is to solve the defects of cyanide-free complexing agents in prior art and provide a complexing agent, which has strong complexing capacity and has a stability constant of 10²⁶⁻²⁷ with copper ions.

Another objective of the present invention is to provide a preparing method of a complexing agent, the preparing method is simple to operate, and a prepared complexing agent is stable in quality and high in purity.

Further objective of the present invention is to provide application of a complexing agent, which is used for preparing an electroplating solution and can improve a complexing capacity of the electroplating solution for metal, since the electroplating solution prepared from the complexing agent is good in quality and good in dispersity, a process current density range that can be adopted is wider and the electroplating solution has a wide application range.

A technical solution adopted by the present invention to solve the technical problems is as follows:

A complexing agent has a general formula MₓH_{y}PₙO₃ₙ₊₁R_{z}, wherein M is any one or more of alkali metal ions and NH4+; R is acyl; x, n and z are positive integers, y is 0 or a positive integer and x+y+z=n+2.

The aforesaid technical solution is explained by plural examples as follows:

a: when x=1, y=1 and z=n, the complexing agent has a general formula MHPₙO₃ₙ₊₁Rₙ and a structural formula is as shown in formula (1):

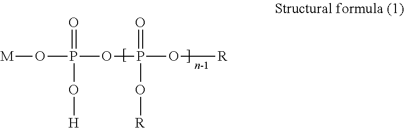

b: when x=n, y=0 and z=2, the complexing agent has a general formula MₙPₙO₃ₙ₊₁R₂ and a structural formula is as shown in formula (2):

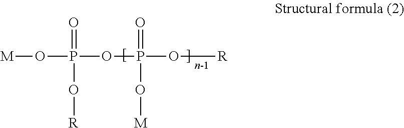

c: when x=1, y=1 and R=2, the complexing agent has a general formula MHₙ₋₁PₙO₃ₙ₊₁R₂ and a structural formula is as shown in formula (3):

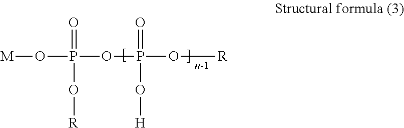

Preferably, the complexing agent has a general formula MₓH_{y}PₙO₃ₙ₊₁R, wherein M is any one or more of Na⁺, K⁺ and NH4+; R is acyl; x, n are positive integers, y is 0 or a positive integer and x+y=n+1.

The aforesaid technical solution is explained by plural examples as follows:

d: when y=0 and x=n+1, the complexing agent has a general formula Mₙ₊₁PₙO₃ₙ₊₁R and a structural formula is as shown in formula (4):

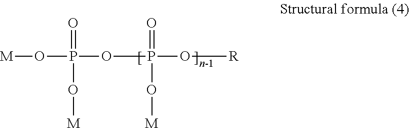

e: when y=1 and x=n, the complexing agent has a general formula MₙHPₙO₃ₙ₊₁R and a structural formula is as shown in formula (5):

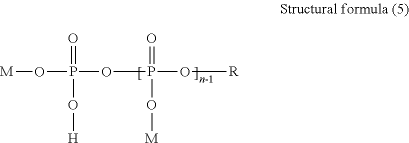

f: when y=n−1 and x=2, the complexing agent has a general formula M₂Hₙ₋₁PₙO₃ₙ₊₁R and a structural formula is as shown in formula (6):

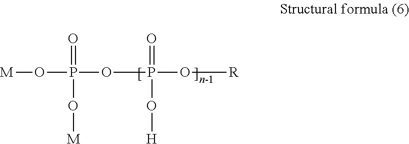

A preparing method of a complexing agent comprises specific operations: mixing alkali, carbonate or bicarbonate containing M, phosphoric acid and an acidic salt of monoprotic organic acids or polybasic organic acids containing an R group for reacting according to a molar ratio, then carrying one step polymerization on a reaction solution at 100-800° C. for 0.5-10 h to obtain a finished product of the complexing agent; or drying the reaction solution firstly, and then polymerizing at 100-800° C. for 0.5-10 h to obtain a finished product of the complexing agent.

In the preparing method of a complexing agent of the present invention, firstly, acid-base neutralization reaction is performed, that is, alkali, carbonate or bicarbonate containing M, phosphoric acid and an acidic salt of monoprotic organic acids or polybasic organic acids containing an R group are mixed for reacting according to a molar ratio, then dehydration polymerization is performed to obtain a finished product of the complexing agent, there are two dehydration polymerization manners as follows: 1. the reaction solution is directly sprayed into a rotary furnace and drying and polymerization are finished at one step at 100-800° C. to obtain a finished product of the complexing agent; 2. the reaction solution is dried in a spray drying or flashing drying manner to obtain partially polymerized intermediate powder in ultra-short time, and the intermediate powder is placed in a device similar to a rake type dryer to be polymerized at 100-800° C. for 0.5-10 h to obtain a finished product of the complexing agent.

Preferably, when M is Na⁺, sodium hydroxide, sodium carbonate or sodium bicarbonate, phosphoric acid and an acidic salt of monoprotic organic acids or polybasic organic acids containing an R group are mixed for reacting according to a molar ratio, then one step polymerization is performed on a reaction solution at 200-400° C. for 0.5-10 h to obtain a finished product of the complexing agent; or the reaction solution is dried firstly, and then is polymerized at 200-400° C. for 0.5-10 h to obtain a finished product of the complexing agent.

For example, M is Na⁺, when x=1, y=1 and z=n, the complexing agent has a general formula NaHPₙO₃ₙ₊₁Rₙ, R is acetyl and the structural formula is as shown in formula (7)

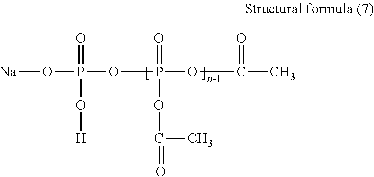

A preparing method of the complexing agent as shown in the structural formula (7) comprises: mixing sodium hydroxide with phosphoric acid and acetic acid for reacting according to a molar ratio of 1:n:n, after the reaction, performing flashing drying on the reaction solution to obtain partially polymerized intermediate powder, and placing the intermediate powder in a rake type stirrer to polymerize at 200-400° C. for 0.5-10 h to obtain a finished product of the complexing agent as shown in formula (7).

Preferably, when M is K⁺, potassium hydroxide, potassium carbonate or potassium bicarbonate, phosphoric acid and an acidic salt of monoprotic organic acids or polybasic organic acids containing an R group are mixed for reacting according to a molar ratio, then one step polymerization is performed on a reaction solution at 250-800° C. for 0.5-10 h to obtain a finished product of the complexing agent; or the reaction solution is dried firstly, and then is polymerized at 250-800° C. for 0.5-10 h to obtain a finished product of the complexing agent.

For example, M is K⁺, when x=n, y=0 and z=2, the complexing agent has a general formula KPₙO₃ₙ₊₁R₂, R is acetyl and the structural formula is as shown in formula (8)

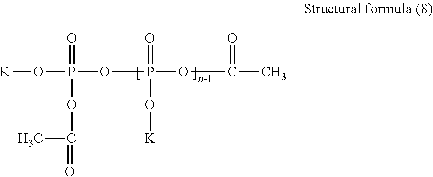

A preparing method of the complexing agent as shown in the structural formula (8) comprises: mixing potassium hydroxide with phosphoric acid and acetic acid for reacting according to a molar ratio of n:n:2, after the reaction, performing spray drying on the reaction solution to obtain partially polymerized intermediate powder, and placing the intermediate powder in a rake type stirrer to polymerize at 250-800° C. for 0.5-10 h to obtain a finished product of the complexing agent as shown in formula (8).

Preferably, when M is NH4+, ammonium hydroxide, ammonium carbonate or ammonium bicarbonate, phosphoric acid and an acidic salt of monoprotic organic acids or polybasic organic acids containing an R group are mixed for reacting according to a molar ratio, then one step polymerization is performed on a reaction solution at 100-300° C. for 0.5-10 h to obtain a finished product of the complexing agent; or the reaction solution is dried firstly, and then is polymerized at 100-300° C. for 0.5-10 h to obtain a finished product of the complexing agent.

Application of a complexing agent is used for preparing an electroplating solution.

Preferably, the electroplating solution is any one of copper plating, tin plating, copper zinc alloy plating, copper tin alloy plating, nickel tin alloy plating, nickel cobalt alloy plating, tin cobalt alloy plating and nickel, tin and cobalt alloy plating electroplating solutions.

Preferably, the use level of the complexing agent in the electroplating solution is 1-60% in mass percent.

The present invention has the beneficial effects: raw materials are wide in source, the price is low, a preparing process, transportation, storage and use are simple, and a production cost is low; the complexing agent of the present invention is used for producing an electroplating solution and is convenient in machining, the prepared electroplating solution is high in complexing capacity for metal, for example, a complexing constant of the complexing agent of the present invention for copper ions is up to 10²⁶⁻²⁷ and far superior than that of the common complexing agents in the prior art, and since the electroplating solution prepared from the complexing agent is good in quality and good in dispersity, a process current density range that can be adopted is wider and the electroplating solution has a wide application range.

### DESCRIPTION OF EMBODIMENTS

The technical solution of the present invention is further and specifically explained by specific embodiments.

Reagents or raw materials in each embodiment are conventional materials purchased from the market and the purity is analytically pure.

### Embodiment 1

A complexing agent has a general formula MₓH_{y}PₙO₃ₙ₊₁R_{z}, wherein x=3, y=0, n=2 and z=1, M is K⁺, R is acetyl and a specific structural formula is as follows:

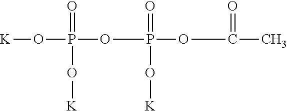

A preparing method of the complexing agent comprises: mixing potassium hydroxide with phosphoric acid and acetic acid for reacting according to a molar ratio of 3:2:1, performing spray drying on the reaction solution to obtain partially polymerized intermediate powder, and placing the intermediate powder in a rake type dryer for polymerization reaction at 250° C. for 10 h to obtain a finished product of the complexing agent after the polymerization reaction is finished.

### Embodiment 2

A complexing agent has a general formula MₓH_{y}PₙO₃ₙ₊₁R_{z}, wherein x=3, y=0, n=3 and z=2, M is K⁺ and Na⁺, R is acetyl and a specific structural formula is as follows:

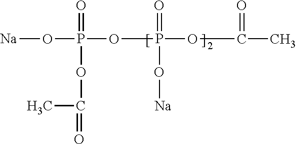

A preparing method of the complexing agent comprises: mixing sodium hydroxide with phosphoric acid and acetic acid for reacting according to a molar ratio of 3:3:2, performing flashing drying on the reaction solution to obtain partially polymerized intermediate powder, and placing the intermediate powder in a rake type dryer for polymerization reaction at 200° C. for 10 h to obtain a finished product of the complexing agent after the polymerization reaction is finished.

### Embodiment 3

A complexing agent has a general formula MₓH_{y}PₙO₃ₙ₊₁R_{z}, wherein x=5, y=0, n=5 and z=2, M is Na⁺, R is acyl formed by dehydrating acetyl and sodium bitartrate and a specific structural formula is as follows:

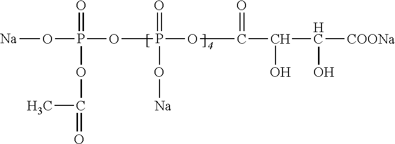

A preparing method of the complexing agent comprises: mixing sodium bicarbonate, phosphoric acid, acetic acid and sodium bitartrate for reacting according to a molar ratio of 5:5:1:1, performing flashing drying on the reaction solution to obtain partially polymerized intermediate powder, and placing the intermediate powder in a rake type dryer for polymerization reaction at 400° C. for 0.5 h to obtain a finished product of the complexing agent after the polymerization reaction is finished.

### Embodiment 4

A complexing agent has a general formula MₓH_{y}PₙO₃ₙ₊₁R_{z}, wherein x=10, y=1, n=10 and z=1, M is K⁺ and Na⁺, R is acyl formed by dehydrating sodium bitartrate and a specific structural formula is as follows:

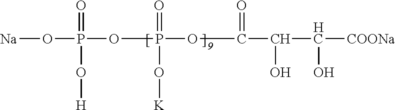

A preparing method of the complexing agent comprises: mixing sodium hydroxide, potassium hydroxide, phosphoric acid and sodium bitartrate for reacting according to a molar ratio of 1:9:10:1, performing spray drying on the reaction solution to obtain partially polymerized intermediate powder, and placing the intermediate powder in a rake type dryer for polymerization reaction at 800° C. for 0.5 h to obtain a finished product of the complexing agent after the polymerization reaction is finished.

### Embodiment 5

A complexing agent has a general formula MₓH_{y}PₙO₃ₙ₊₁R_{z}, wherein x=10, y=1, n=10 and z=1, M is Na⁺, R is acyl formed by dehydrating disodium hydrogen citrate and a specific structural formula is as follows:

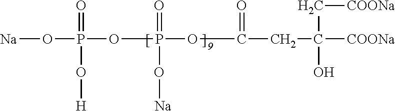

A preparing method of the complexing agent comprises: mixing sodium carbonate, phosphoric acid and disodium hydrogen citrate for reacting according to a molar ratio of 5:10:1, performing flashing drying on the reaction solution to obtain partially polymerized intermediate powder, and placing the intermediate powder in a rake type dryer for polymerization reaction at 400° C. for 0.5 h to obtain a finished product of the complexing agent after the polymerization reaction is finished.

### Embodiment 6

A complexing agent has a general formula MₓH_{y}PₙO₃ₙ₊₁R_{z}, wherein x=1, y=100, n=100 and z=1, M is Na⁺, R is acylamino formed by dehydrating alanine and a specific structural formula is as follows:

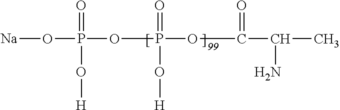

A preparing method of the complexing agent comprises: mixing sodium bicarbonate, phosphoric acid and alanine for reacting according to a molar ratio of 1:100:1, performing flashing drying on the reaction solution to obtain partially polymerized intermediate powder, and placing the intermediate powder in a rake type dryer for polymerization reaction at 300° C. for 2.5 h to obtain a finished product of the complexing agent after the polymerization reaction is finished.

### Embodiment 7

A complexing agent has a general formula MₓH_{y}PₙO₃ₙ₊₁R_{z}, wherein x=1, y=100, n=100 and z=1, M is Na⁺, R is acetyl and a specific structural formula is as follows:

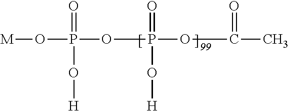

A preparing method of the complexing agent comprises: mixing sodium bicarbonate, phosphoric acid and acetic acid for reacting according to a molar ratio of 1:100:1, performing flashing drying on the reaction solution to obtain partially polymerized intermediate powder, and placing the intermediate powder in a rake type dryer for polymerization reaction at 300° C. for 2.5 h to obtain a finished product of the complexing agent after the polymerization reaction is finished.

### Embodiment 8

A complexing agent has a general formula MₓH_{y}PₙO₃ₙ₊₁R_{z}, wherein x=3, y=0, n=2 and z=1, M is Na⁺, R is acyl formed by dehydrating methyl orthophosphoric acid and a specific structural formula is as follows:

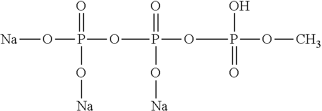

A preparing method of the complexing agent comprises: mixing sodium hydroxide, phosphoric acid and methyl orthophosphoric acid for reacting according to a molar ratio of 3:2:1, performing flashing drying on the reaction solution to obtain partially polymerized intermediate powder, and placing the intermediate powder in a rake type dryer for polymerization reaction at 300° C. for 5 h to obtain a finished product of the complexing agent after the polymerization reaction is finished.

The aforesaid complexing agents are used for preparing an electroplating solution, and the electroplating solution is any one of copper plating, tin plating, copper zinc alloy plating, copper tin alloy plating, nickel tin alloy plating, nickel cobalt alloy plating, tin cobalt alloy plating and nickel, tin and cobalt alloy plating electroplating solutions.

The copper plating electroplating solution is taken as an example, specifically:

### Embodiment 9

The complexing agent prepared in embodiment 7 is used for preparing a cyanide-free copper preplating electroplating solution, and a preparing method of the electroplating method comprises:

(1) preparing a copper salt: uniformly mixing the complexing agent prepared in embodiment 7 with copper sulfate according to a molar ratio of 2:1, reacting for 1.0 h at normal temperature, and centrifuging for separation and drying to obtain the copper salt after the reaction, wherein a structural formula of the copper salt is as follows:

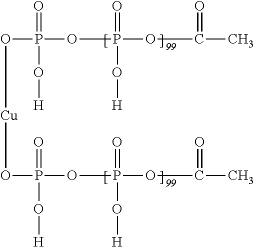

(2) preparing the electroplating solution: proportionally and uniformly mixing 1% (mass percent) of the complexing agent in embodiment 7, 0.5% of the copper salt prepared in step (1) and 98.5% of purified water, and then regulating pH to 8.5 with potassium hydroxide to obtain the cyanide-free copper preplating electroplating solution.

### Embodiment 10

The complexing agent prepared in embodiment 8 is used for preparing a cyanide-free copper preplating electroplating solution, and a preparing method of the electroplating method comprises:

(1) preparing a copper salt: uniformly mixing the complexing agent prepared in embodiment 8 with copper sulfate according to a molar ratio of 2:3, reacting for 1.0 h at normal temperature, and centrifuging for separation and drying to obtain the copper salt after the reaction, wherein a structural formula of the copper salt is as follows:

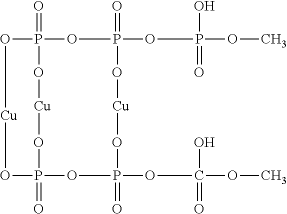

(2) preparing the electroplating solution: proportionally and uniformly mixing 60% (mass percent) of the complexing agent in embodiment 8, 5% of the copper salt prepared in step (1) and 35% of purified water, and then regulating pH to 9.5 with potassium hydroxide to obtain the cyanide-free copper preplating electroplating solution.

The cyanide-free copper preplating electroplating solutions in embodiment 9 and embodiment 10 are researched as follows.

1. Hull cell test (267 ml)

1.1 Preliminary test: the electroplating solutions prepared in embodiment 9 and embodiment 10 are used for sheet plating under the conditions of 25° C., current 1 A (stable) and air stirring for 5 min, and characteristics of relatively stable cell voltage and semi light spots and fine crystal on a large area of the plated sheet are observed under the condition of stable current in the sheet plating process.

1.2 Current density ranged determined by the Hull cell test

The electroplating solutions prepared in embodiment 9 and embodiment 10 are used for sheet plating through Hull under the conditions of 55° C. and current 1 A for 10 min to determine an optimal current density range, and the sheet for sheet plating is a 0.5*70*100 A3 steel sheet, which is sanded and polished with 600# waterproof abrasive paper. A current density of each spot is calculated by referring to an empirical formula Jₖ=I(5.1-5.24 LgL). It can be obtained by sheet plating and calculating the current density that a current density range of the electroplating solutions prepared in embodiment 9 and embodiment 10 is between 0.5 A/dm² and 2.5 A/dm².

2. Electroplating solution and electroplating performance test

2.1 Determining of current efficiency: a copper coulombmeter is adopted to measure, the current efficiency of the electroplating solution prepared in embodiment 9 is 93.0% and the current efficiency of the electroplating solution prepared in embodiment 10 is 93.8%.

2.2 Electroplating solution dispersity determining:

A cathode bending method is used to determine the dispersity of the electroplating solution under the conditions of current 1 A, oil-free air stirring and 55° C. for 30 min, a test material adopts a 0.5*70*100 A3 copper sheet, which is sanded and polished with 600# waterproof abrasive paper.

Through determining, the dispersity of the electroplating solution in embodiment 9 is 93.5%, and the dispersity of the electroplating solution in embodiment 10 is 93.1%.

2.3 Determining of covering capacity

An inner hole method is adopted to measure the covering capacity of the electroplating solution, a copper pipe has a size of 10 mm*100 mm, a through hole and blind hole method is adopted, the electroplating solution is at 55° C., a cathode current density is 0.5 A/dm², and time is 5 min. After the test, the iron pipe is sectioned to observe a plating condition in the pipe.

The electroplating solutions in embodiment 9 and embodiment 10 are used as test electroplating solutions, after the test, it is found that through holes and blind holes are plated with a copper layer, which indicates that the covering capacity of the electroplating solutions prepared in embodiment 9 and embodiment 10 are good.

2.4 Binding force test

2.4.1 Bending test: a polished iron sheet (A3) which is 0.5 mm thick is adopted, the electroplating solution is at 55° C., a cathode current density is 2 A/dm², and time is 15 min.

The electroplating solutions in embodiment 9 and embodiment 10 are used as test electroplating solutions, after the test, the plated test sheet is repeatedly bent till breakage, no peeling phenomenon exists at the cracks, proving that the plating and a substrate are basically not separated.

2.4.2 Thermal shock test: a polished iron sheet (A3) which is 0.5 mm thick is adopted, the electroplating solution is at 55° C., a cathode current density is 2 A/dm², and time is 15 min.

The electroplating solutions in embodiment 9 and embodiment 10 are used as test electroplating solutions, after the test, the plated test sheet is placed in an oven till 200° C., is continuously baked for 1 h, and is immediately immersed in 0° C. water for shock chilling, and a result is that the plating has no blistering and peeling phenomena.

2.5 Plating tenacity test: an A3 steel sheet which is 0.1 mm thick is passivated with lead acid, and is directly hung in the electroplating solutions prepared in embodiment 9 and embodiment 10 after cleaning, the plating is peeled after the thickness of the plating is 20 μm and is bent for 180 degrees, the bent part is extruded, and the plating is not broken which indicates that the plating is good in tenacity.

2.6 Plating porosity test: a polished iron sheet (A3) which is 0.5 mm thick is adopted, the electroplating solution is at 55° C., a cathode current density is 1 A/dm², time is 20 min, and the porosity test is performed by adopting an experiment method of attaching a potassium ferricyanide solution to filter paper.

Potassium ferricyanide is 10 g/l; sodium chloride is 20 g/l.

A test result shows that the porosity of the electroplating layer formed by taking the electroplating solutions in embodiment 9 and embodiment 10 as test objects is smaller than or equal to 1/dm².

2.7 Deposition rate determining: current is set to be 1 A, temperature is 55° C., and time is 30 min; a determining result shows that the deposition rate of the electroplating solution prepared in embodiment 9 is 0.6 μm/min, and the deposition rate of the electroplating solution prepared in embodiment 10 is 0.52 μm/min.

The electroplating solutions prepared in embodiment 9 and embodiment 10 are subjected to a pilot test further, wherein pilot test parameters are as follows:

Process flow: steel workpiece, ultrasonic deoiling, water washing 1, water washing 2, anode electrolysis deoiling, water washing 1, water washing 2, pickling deoiling, water washing 1, water washing 2, hydrochloric acid washing, water washing 1, water washing 2, terminal electrolysis deoiling, water washing 1, water washing 2, acid activating, water washing 1, water washing 2, electroplating solution in embodiment 9 or embodiment 10, recycling, water washing 1, water washing 2, acid activating and copper acidizing.

Ultrasonic deoiling: concentration of deoiling powder is 50±5 g/L, temperature is 70±5° C., current density is 1-5 A/dm² and time is 5 min.

Cathode electrolysis deoiling: concentration of electrolysis deoiling powder is 50±5 g/L, temperature is 70±5° C., current density is 1-5 A/dm² and time is 5-7 min.

Anode electrolysis deoiling: concentration of electrolysis deoiling powder is 50±5 g/L, temperature is 70±5° C., current density is 1-5 A/dm² and time is 3-5 min.

Pickling: concentration of technical hydrochloric acid is 15-20%, time is 8-10 min and temperature is room temperature.

Activating: concentration of technical hydrochloric acid is 5-10%, time is 3-5 min and temperature is room temperature.

The electroplating solution in embodiment 9 or embodiment 10: a baume degree is 32-36, a pH value is 8.5-9.5, temperature is 50-55° C., a current density is 0.5-2.5 A/dm², time is 5 min to several hours, and practice proves that the flatness and brightness are still very good till plating to 100 μm.

Through continuous operation of a 50 L pilot test electroplating production line for 20 months and continuous operation of a 350 L pilot test electroplating production line for 11 months, it is proved that the electroplating solution prepared in embodiment 9 or embodiment 10 has reliability, is stable in performance, and has consumption of 10-50 ml/KAH.

Based on the pilot test, process conditions of the electroplating solution prepared in embodiment 9 or embodiment 10 for industrial production are obtained.

1. Steel workpiece:

Process flow: steel workpiece, ultrasonic deoiling, water washing 1, water washing 2, anode electrolysis deoiling, water washing 1, water washing 2, pickling deoiling, water washing 1, water washing 2, hydrochloric acid washing, water washing 1, water washing 2, terminal electrolysis deoiling, water washing 1, water washing 2, acid activating, water washing 1, water washing 2, presoaking, electroplating solution in embodiment 9 or embodiment 10, recycling, water washing 1, water washing 2, acid activating and copper acidizing.

Process conditions:

Electroplating solution density: 32-36 baume degrees

Temperature: 45-60° C.

pH value: 8.60-9.50

Stirring: air stirring plus cathode moving

Anode: electrolysis copper or anaerobic electrolysis copper

Ratio of a cathode area to an anode area: 1:1.5-2

Current: 0.5-2.5 A/dm²

2. Zinc alloy workpiece:

Process flow: zinc alloy workpiece, hot dipping dewaxing, ultrasonic dewaxing, water washing 1, water washing 2, ultrasonic deoiling, water washing 1, water washing 2, anode electrolysis deoiling, water washing 1, water washing 2, hydrochloric acid activating, water washing 1, water washing 2, presoaking in ultrasonic presoaking solution for 30 s, electroplating solution in embodiment 9 or embodiment 10 (placing in a cell in an electrified state at 25-35° C.), recycling, water washing 1, water washing 2, acid activating and copper acidizing.

Process conditions:

Electroplating solution density: 32-38 baume degrees

Temperature: 25-35° C.

pH value: 8.60-9.50

Stirring: air stirring plus cathode moving

Anode: electrolysis copper or anaerobic electrolysis copper

Ratio of a cathode area to an anode area: 1:1.5-2

Current: 0.5-1.5 A/dm²

Aforesaid embodiments are merely preferably solutions of the present invention instead of limiting the present invention in any form, and other variants and modifications can be realized under the premise of not changing the technical solution recorded in claims.

1. A complexing agent, wherein the complexing agent has a general formula MₓH_{y}PₙO₃ₙ₊₁R_{z}, wherein M is any one or more of alkali metal ions and NH₄⁺; R is acyl; x, n and z are positive integers, y is 0 or a positive integer, and x+y+z=n+2.

2. The complexing agent of claim 1, wherein the complexing agent has a general formula MₓH_{y}PₙO₃ₙ₊₁R, wherein M is any one or more of Na+, K+ and NH₄⁺; R is acyl; x and n are positive integers, y is 0 or a positive integer, and x+y=n+1.

3. A method of preparing the complexing agent of claim 1, the method comprising:
mixing alkali, carbonate or bicarbonate containing M, phosphoric acid and an acidic salt of monoprotic organic acids or polybasic organic acids containing an R group according to a molar ratio to form a reaction solution,
optionally drying the reaction solution, and
performing one step polymerization of the reaction solution at 100-800° C. for 0.5-10 hours to obtain the complexing agent.

4. The method of claim 3, wherein M is Na⁺; sodium hydroxide, sodium carbonate or sodium bicarbonate, phosphoric acid and an acidic salt of monoprotic organic acids or polybasic organic acids containing an R group are mixed according to a molar ratio to form the reaction solution; and the one step polymerization is performed at 200-400° C. for 0.5-10 hours to obtain the complexing agent.

5. The method of claim 3, wherein M is K⁺; potassium hydroxide, potassium carbonate or potassium bicarbonate, phosphoric acid and an acidic salt of monoprotic organic acids or polybasic organic acids containing an R group are mixed according to a molar ratio to form the reaction solution; and the one step polymerization is performed at 250-800° C. for 0.5-10 hours to obtain the complexing agent.

6. The method of claim 3, wherein when M is NH₄⁺; ammonium hydroxide, ammonium carbonate or ammonium bicarbonate, phosphoric acid and an acidic salt of monoprotic organic acids or polybasic organic acids containing an R group are mixed according to a molar ratio to form the reaction solution; and the one step polymerization is performed at 100-300° C. for 0.5-10 hours to obtain the complexing agent.

7-9. (canceled)

10. A method of preparing the complexing agent of claim 2, the method comprising:
mixing alkali, carbonate or bicarbonate containing M, phosphoric acid and an acidic salt of monoprotic organic acids or polybasic organic acids containing an R group according to a molar ratio to form a reaction solution,
optionally drying the reaction solution, and
performing one step polymerization of the reaction solution at 100-800° C. for 0.5-10 hours to obtain the complexing agent.

11. The method of claim 10, wherein M is Na⁺; sodium hydroxide, sodium carbonate or sodium bicarbonate, phosphoric acid and an acidic salt of monoprotic organic acids or polybasic organic acids containing an R group are mixed according to a molar ratio to form the reaction solution; and the one step polymerization is performed at 200-400° C. for 0.5-10 hours to obtain the complexing agent.

12. The method of claim 10, wherein M is K⁺; potassium hydroxide, potassium carbonate or potassium bicarbonate, phosphoric acid and an acidic salt of monoprotic organic acids or polybasic organic acids containing an R group are mixed according to a molar ratio to form the reaction solution; and the one step polymerization is performed at 250-800° C. for 0.5-10 hours to obtain the complexing agent.

13. The method of claim 10, wherein when M is NH₄⁺; ammonium hydroxide, ammonium carbonate or ammonium bicarbonate, phosphoric acid and an acidic salt of monoprotic organic acids or polybasic organic acids containing an R group are mixed according to a molar ratio to form the reaction solution; and the one step polymerization is performed at 100-300° C. for 0.5-10 hours to obtain the complexing agent.

14-16. (canceled)

17. A method, comprising mixing the complexing agent of claim 1 with a salt to form an electroplating solution.

18. The method of claim 17, wherein the electroplating solution is any one of copper plating, tin plating, copper zinc alloy plating, copper tin alloy plating, nickel tin alloy plating, nickel cobalt alloy plating, tin cobalt alloy plating and nickel, tin and cobalt alloy plating electroplating solutions.

19. The method of claim 17, wherein the complexing agent is in the amount of 1-60% in mass percent of the electroplating solution.

20. A method, comprising mixing the complexing agent of claim 2 with a salt to form an electroplating solution.

21. The method of claim 20, wherein the electroplating solution is any one of copper plating, tin plating, copper zinc alloy plating, copper tin alloy plating, nickel tin alloy plating, nickel cobalt alloy plating, tin cobalt alloy plating and nickel, tin and cobalt alloy plating electroplating solutions.

22. The method of claim 20, wherein the complexing agent is in the amount of 1-60% in mass percent of the electroplating solution.
